(19) United States
(12) Patent Application Publication
(10) Pub. No.: US 2026/0190025 A1
(43) Pub. Date: Jul. 2, 2026

(54) FAST PDCCH MONITORING IN CARRIER AGGREGATION FOR XR SERVICES

(71) Applicant: TELEFONAKTIEBOLAGET LM ERICSSON (PUBL), STOCKHOLM (SE)

(72) Inventors: Du Ho Kang, Stockholm (SE); Jose Luis Pradas, Stockholm (SE)

(21) Appl. No.: 19/128,123

(22) PCT Filed: Nov. 7, 2023
(86) PCT No.: PCT/IB2023/061244

§ 371 Date: May 7, 2025

Related U.S. Application Data
(60) Provisional application No. 63/423,243, filed on Nov. 7, 2022.

(51) Int. Cl. H04W 52/02; H04W 76/28

(52) U.S. Cl. CPC H04W 52/0216; H04W 52/0235; H04W 76/28

(57) ABSTRACT

Various embodiments disclosed herein provide for a method for configuring a User Equipment (UE) to be in a long sleep mode by modifying either the Discontinuous Reception (DRX) cycle in the Secondary Cells or by using Physical Downlink Control Channel (PDCCH) skipping. Once in the long sleep, the UE can be provided with an indication via the Primary Cell to start monitoring the PDCCH. If PDCCH skipping is used, the UE can be provided with an indication that would force the UE to monitor PDCCH, and the UE could be provided with an indication that would result in an “early” start of the Active Time if the DRX configuration was used. The network sends an indication to ensure secondary cell group to minimize PDCCH monitoring when a traffic is not present but to quickly restart PDCCH monitoring in the secondary cell group when traffic is present.

### RELATED APPLICATIONS

This application claims the benefit of provisional patent application Ser. No. 63/423,243, filed Nov. 7, 2022, the disclosure of which is hereby incorporated herein by reference in its entirety.

### TECHNICAL FIELD

The present disclosure relates to fast Physical Downlink Control Channel (PDCCH) monitoring in Carrier Aggregation for extended Reality (XR) services and other low latency, high bandwidth situations in a wireless communication system.

### BACKGROUND

Fifth Generation (5G) New Radio (NR) is designed to support applications demanding high rate and low latency in line with the requirements posed by the support of extended Reality (XR) and cloud gaming applications in NR networks. 3^{rd} Generation Partnership Project (3GPP) Release 17 contains a study item on XR Evaluations for NR. The main objectives are to identify the traffic model for each application of interest, the evaluation methodology and the key performance indicators of interest for relevant deployment scenarios, and to carry out performance evaluations accordingly in order to investigate possible standardization enhancements in potential follow-up Study Item (SI)/Work Item (WI).

### Low-Latency High-Rate Applications

The low-latency applications like XR and cloud gaming require bounded latency, not necessarily ultra-low latency. The end-to-end latency budget may be in the range of 20-80 ms, which needs to be distributed over several components including application processing latency, transport latency, radio link latency, etc. For these applications, short Transmission Time Intervals (TTIs) or mini-slots targeting ultra-low latency may not be effective.

FIG. 1 shows an example of frame latency measured over Radio Access Network (RAN), excluding application and core network latencies. It can be seen that there exist frame latency spikes (e.g., 102, 104) in RAN. The sources for the latency spikes may include queuing delay, time-varying radio environments, time-varying frame sizes, among others. Tools that can help to remove latency spikes are beneficial to enable better 5G support for this type of traffic.

In addition to bounded latency requirements, the applications like XR and cloud gaming also require high-rate transmission. This can be seen from the large frame sizes originated from this type of traffic. The typical frame sizes may range from tens of kilobytes to hundreds of kilobytes. The frame arrival rates may be 60 or 120 Frames Per Second (fps). As a concrete example, a frame size of 100 kilobytes and a frame arrival rate of 120 fps can lead to a rate requirement of 95.8 Mbps.

A large video frame is usually fragmented into smaller Internet Protocol (IP) packets and transmitted as several Transport Blocks (TBs) over several TTIs in RAN. FIG. 2 shows an example of the cumulative distribution functions (CDF) of the number of transport blocks required to deliver a video frame with size ranging from 20 KB (202) to 300 KB (206). For example, FIG. 2 shows that for delivering the frames with a size of 100 KB (204) each, the median number of needed TBs is 5 (e.g., 208).

### Power Considerations for XR and Cloud Gaming

In addition to Smartphone based XR, XR experience is increasingly expected to be delivered via Head Mounted Displays (HMDs). The power considerations for HMDs are different from those of Smartphones. In particular, the power dissipation of Augmented Reality (AR) glasses can be significantly lower than that of a smartphone, if the AR glass form factor is similar to that of prescription glasses and is expected to be worn for long durations. The AR glasses can have an embedded 5G modem providing 5G connectivity, or the AR glasses can be tethered (USB, Bluetooth, or WiFi) to a Smartphone for 5G connectivity. In both cases, the 5G connection must carry AR application traffic, and the User Equipment (UE) power consumption from that traffic has a significant bearing on the viability of such AR glasses products.

Further, the AR computation can be split between the AR glasses and Edge servers as discussed before. The computation split can reduce the overall power consumption on the device if the resulting traffic from the computation split does not increase the UE power consumption significantly.

In the case of Cloud Gaming, the device is expected to be a Smartphone or Tablet. The power consumption and battery life of the device for a long duration Cloud Gaming experience is an important aspect to consider.

As such, power consumption is an important factor for XR and Cloud Gaming.

### DRX Mechanism

The 3GPP specifications for NR and Long Term Evolution (LTE) specify procedures for Discontinuous Reception (DRX), which is adopted as an effective power saving mechanism. DRX mechanism allows UE save battery power by monitoring DL control channel less frequently and go for sleep whenever there is no packet activity for the UE. DRX can be configured in Radio Resource Control (RRC) IDLE and/or in RRC_CONNECTED independently.

FIG. 3 shows a simplified version of the DRX operation. The DRX cycle, drx_onDurationTimer and drx_InactivityTimer are configured by Radio Resource Control (RRC) and the values are fixed i.e., they are not dynamically changed or adjusted. The “Active Time” 302 is the period of time in which the UE monitors Physical Downlink Control Channel (PDCCH) within a DRX cycle 304. As used herein, that is the period of time while drx-onDurationTimer or drx-InactivityTimer is running (it is to be noted that the “Active Time” is also affected by other timers which are not being discussed in this context). There are two DRX operation modes: short and long DRX cycles. The network via RRC signaling configures the UE DRX parameters and the DRX operation mode, Short DRX and/or Long DRX. During the time the drx_OnDuration Timer is running, the UE monitors PDCCH. If the UE successfully decodes a PDCCH, the UE starts the drx_InactivityTimer. If no new PDCCH is received while any of the two timers is running, the UE moves into the “sleep period” 306 in which the UE does not monitor PDCCH until the next DRX cycle.

Mechanisms to switch between long DRX and short DRX cycles have been introduced as well as mechanisms to stop the drx_OnDurationTimer and drx_InactivityTimer. Medium Access Control (MAC) Control Element (CE) commands: DRX Command MAC CE and Long DRX Command MAC CE. These mechanisms allow the UE to stop the PDCCH monitoring period and go to the “sleep period” which shorterns the UE power consumption. FIG. 4 shows an example in which MAC CE command is received to stop the drx_InactivityTimer. The figure shows the Physical Downlink Shared Channel (PDSCH) decoding time as well as the savings which could be achieved due to the fact the UE stops PDCCH monitoring earlier. The downside of this solution is that the network needs to allocate PDCCH resources and well as PDSCH resources to transmit the MAC CE.

The following definitions provide a limited description of the connected mode DRX variables. The complete list of parameters is available in 3GPP TS 38.321.

Drx-onDurationTimer: Time during which UE waits to receive PDCCH after waking up from DRX. The duration at the beginning of a DRX cycle. This phase defines the minimum average awake time of a UE; and according to 3GPP TS 38.331, this time value can be configured from 1 to 1600 ms.

Drx-InactivityTimer: the duration after the PDCCH occasion in which a PDCCH indicates a new uplink (UL) or downlink (DL) transmission for the MAC entity.

The UE starts the first inactivity timer supervising the switch to discontinuous reception when it successfully decodes PDCCH for a first transmission (not for retransmissions). If short DRX is configured, the UE starts the inactivity timer supervising the switch from short DRX cycles to long DRX cycles when it enters DRX (i.e., at expiry of the former timer). According to 3GPP TS 38.331, this time value can be configured from 0 to 2560 ms.

DRX cycle: It is defined as the total time of active time and UE sleep time. This is also configurable, however should be a trade-off value between UE battery saving and UE delay requirement.

In 3GPP TS 38.331 for long DRX cycle this value can vary from 10 to 10240 ms and for short DRX cycle this value can vary from 2 to 640 ms.

Active-time: The total time during which the UE monitors PDCCH, and it includes the time while [3GPP TS 38.321, subclause 5.7]:
drx-onDurationTimer or drx-InactivityTimer configured for the DRX group is running; or
drx-RetransmissionTimerDL or drx-RetransmissionTimerUL is running on any Serving Cell in the DRX group; or
ra-ContentionResolutionTimer or msgB-Response Window is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble.

The parameters listed above show a simplified view of the DRX operation. In some embodiments, DRX operation is more complex and its operation depends on more variables and timers:
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-ShortCycleTimer (optional): the duration the UE shall follow the Short DRX cycle;
drx-HARQ-RTT-TimerDL (per DL Hybrid Automatic Repeat Request (HARQ) process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup (optional): the configuration to start associated drx-onDurationTimer in case DCP is monitored but not detected;
ps-Periodic_CSI_Transmit (optional): the configuration to report periodic Channel State Information (CSI) during the time duration indicated by drx-onDurationTimer in case DCP is configured but associated drx-onDurationTimer is not started;
ps-TransmitPeriodicL1-RSRP (optional): the configuration to transmit periodic L1-RSRP report(s) during the time duration indicated by drx-onDurationTimer in case DCP is configured but associated drx-onDurationTimer is not started.

### Carrier Aggregation

In Carrier Aggregation (CA), two or more Component Carriers (CCs) can be aggregated. This means that a UE may simultaneously receive or transmit on one or multiple CCs. In CA, there is one Primary Cell (PCell), and this cell is the one providing the signalling, such as RRC, security input, or NAS information. Secondary Cells (SCell) can be configured and together with the Pcell, they are known as serving cells. There can only be one PCell and one or more SCells.

### SCell Activation/Deactivation

If the MAC entity is configured with one or more SCells, the network may activate and deactivate the configured SCells. Upon configuration of an SCell, the SCell is deactivated unless the parameter SCellState is set to activated for the SCell by upper layers. The configured SCell(s) is activated and deactivated by:
receiving the SCell Activation/Deactivation MAC CE
configuring SCellDeactivationTimer timer per configured SCell (except the SCell configured with PUCCH, if any): the associated SCell is deactivated upon its expiry
configuring SCellState per configured SCell: if configured, the associated SCell is activated upon SCell configuration.

### DRX and CA

Serving Cells of a MAC entity may be configured by RRC in two DRX groups with separate DRX parameters. When two DRX groups are configured, each Serving Cell is uniquely assigned to either of the two groups. When there is one DRX group, all Serving Cells belong to that one DRX group. The DRX parameters that are separately configured for each DRX group are: drx-onDurationTimer, drx-InactivityTimer.

### SUMMARY

Various embodiments disclosed herein provide for a method for configuring a User Equipment (UE) to be in a long sleep mode by modifying either the Discontinuous Reception (DRX) cycle in the Secondary Cells (SCell) or by using Physical Downlink Control Channel (PDCCH) skipping. Once in the long sleep, the UE can be provided with an indication via the Primary Cell (PCell) to start monitoring the PDCCH. If PDCCH skipping is used, the UE can be provided with an indication that would force the UE to monitor PDCCH, and if the DRX configuration was used, the UE could be provided with an indication that would result in an “early” start of the Active Time. The network sends an indication to ensure secondary cell group minimizes PDCCH monitoring when a traffic is not present but quickly to restart PDCCH monitoring in the secondary cell group without extra delay when a traffic is present.

In an embodiment, a method can be performed by a UE for receiving configuration to be in a long sleep mode, and the method can include receiving, from a network node, a configuration to use Carrier Aggregation (CA) with one or more PCells and one or more SCells receiving, from the network node, a configuration to be put in a long sleep using either PDCCH skipping or by modifying DRX to configure long DRX cycles in one or more of the SCells. If the configuration is to use PDCCH skipping, the method can include receiving, from the network node, an indication to force monitoring of the PDCCH and if the configuration is to modify DRX, the method can include receiving, from the network node, an indication to initiate a start of the Active Time of DRX, resulting in the monitoring of the PDCCH.

In an embodiment, the indication is received over a cell on which the UE is monitoring the PDCCH.

In an embodiment, the cell is a PCell.

In an embodiment, the indication is for one or more SCells.

In an embodiment, a PDCCH skipping value is pre-configured via Radio Resource Control (RRC) or is indicated dynamically.

In an embodiment, the configuration to use PDCCH skipping indication also indicates to which SCells the configuration applies.

In an embodiment, a PDCCH skipping indication applies to all SCells of the one or more SCells.

In an embodiment, the configuration to use PDCCH skipping is received via PDCCH or in a Medium Access Control (MAC) Control Element (CE).

In an embodiment, the configuration to use PDCCH skipping indicates a length of PDCCH skipping which applies to all cells to which the PDCCH skipping applies, or individually for each of the SCells to which the PDCCH skipping applies.

In an embodiment, a UE that is configured to receive a configuration to be in a long sleep mode can include a radio and processing circuitry that is configured to perform the methods of any of the embodiments described above.

In an embodiment, a UE is provided that is configured to receive a configuration to be in a long sleep mode can include a radio and processing circuitry that is configured to perform the methods of any of the embodiments described above.

In an embodiment, a method can be performed by a network node for configuring a UE to be in a long sleep mode, and the method can include providing a configuration to use CA with one or more PCells and one or more SCells and providing a configuration to put the UE in a long sleep using either PDCCH skipping or by modifying DRX to configure long DRX cycles in one or more of the SCells. If the configuration is to use PDCCH skipping, the method can include providing an indication to force monitoring of the PDCCH and if the configuration is to modify DRX, the method can include receiving, from the network node, an indication to initiate a start of the Active Time of DRX, resulting in the monitoring of the PDCCH.

In an embodiment, a network node is provided that is configured to configure a UE to be in a long sleep mode can include a radio and processing circuitry that is configured to perform the methods of any of the embodiments described above.

These embodiments may provide one or more technical advantages, including, but not limited to reducing latency to transmit Physical Downlink Shared Channel (PDSCH) in SCells without any activation delay of SCells, reducing PDCCH monitoring power consumption in the secondary cell group using dynamic indication; and MAC CE activation of DRX in one or more SCells.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an exemplary graph depicting frame latency measurement in a radio access network according to an embodiment of the present disclosure;

FIG. 2 is an exemplary graph depicting cumulative distribution functions of a number of transport blocks required to deliver a video frame according to an embodiment of the present disclosure;

FIG. 3 is an exemplary block diagram of a Discontinuous Reception (DRX) Mechanism according to an embodiment of the present disclosure;

FIG. 4 is an exemplary block diagram of a DRX Operation with a Medium Access Control (MAC) Control Element (CE) command according to an embodiment of the present disclosure;

FIG. 5 is an exemplary block diagram of a delay of data transmission in a Secondary Cell (SCell) due to Channel Quality Indicator (CQI) reception according to an embodiment of the present disclosure;

FIG. 6 is an exemplary block diagram depicting a DRX configuration of a User Equipment (UE) to run different DRX cycles according to an embodiment of the present disclosure;

FIG. 7 is an exemplary flowchart of a method performed by a UE for receiving configuration to be in a long sleep mode according to an embodiment of the present disclosure;

FIG. 8 is an exemplary flowchart of a method for configuring a UE to be in a long sleep mode according to an embodiment of the present disclosure;

FIG. 9 shows an example of a communication system in accordance with some embodiments of the present disclosure;

FIG. 10 shows a UE in accordance with some embodiments of the present disclosure;

FIG. 11 shows a network node in accordance with some embodiments of the present disclosure;

FIG. 12 is a block diagram of a host, which may be an embodiment of the host of FIG. 9, in accordance with various aspects of the present disclosure described herein;

FIG. 13 is a block diagram illustrating a virtualization environment in which functions implemented by some embodiments of the present disclosure may be virtualized; and

FIG. 14 shows a communication diagram of a host communicating via a network node with a UE over a partially wireless connection in accordance with some embodiments of the present disclosure.

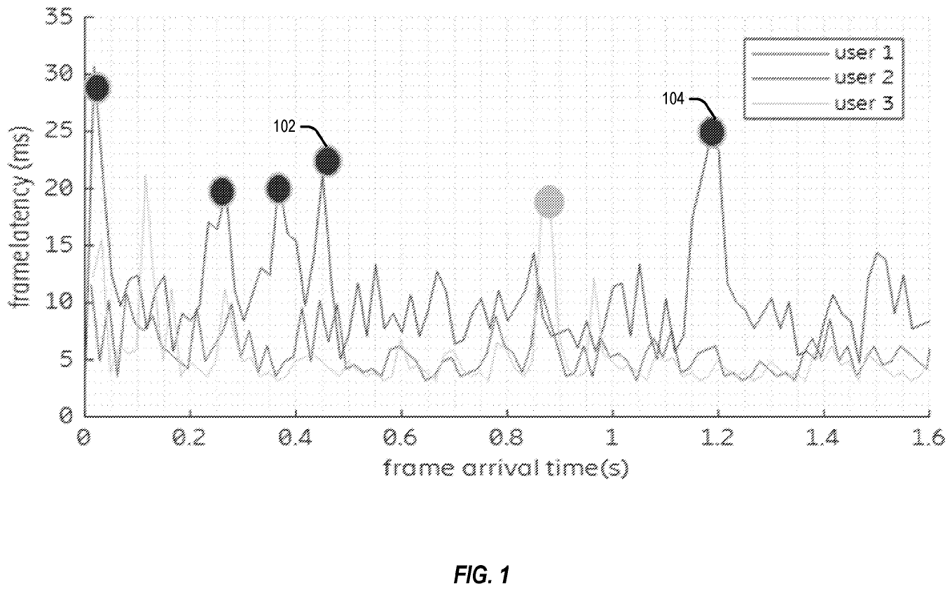

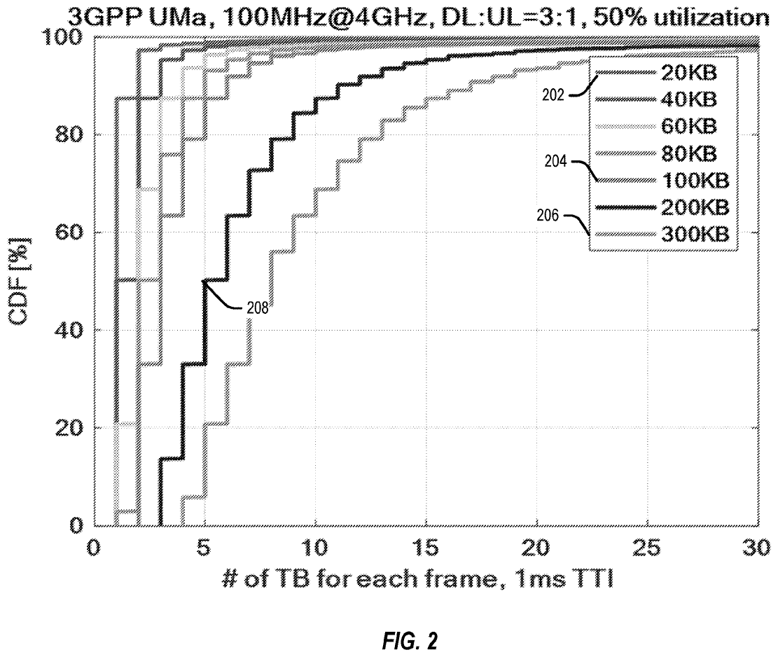

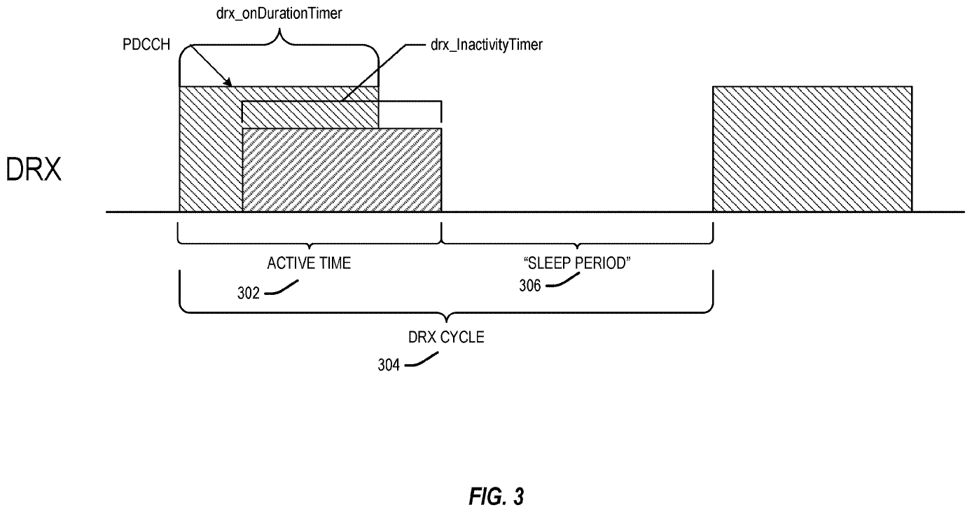

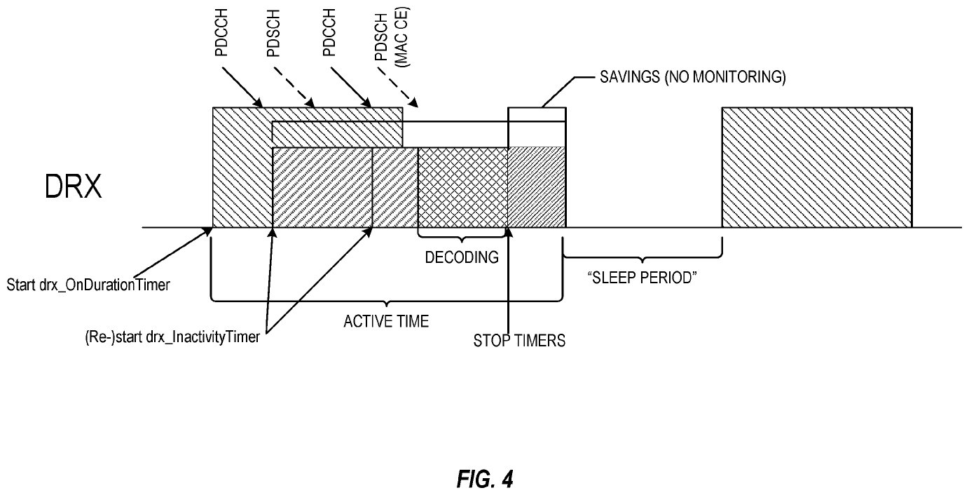

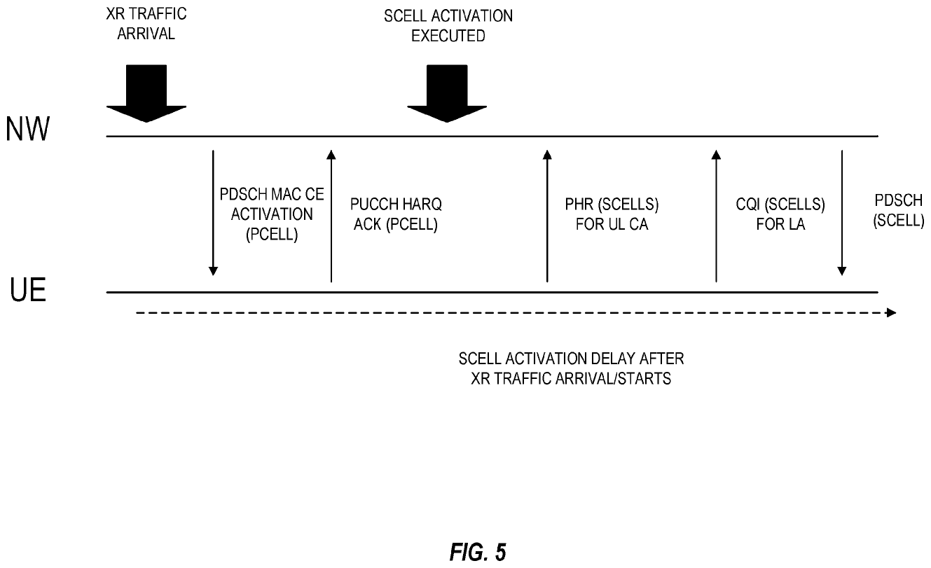

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). Extended Reality (XR) traffic and, especially video traffic, is characterized by periodic, large, and variable application Protocol Data Units (PDUs) size and also requires low latency for fast response and interactive communication. When a XR service is started. In addition, the new device for XR is expected to be small and lighter than typical smartphones so that it becomes very crucial to keep power consumption low enough by activating many power saving features.

Activating a carrier typically takes some time. The User Equipment (UE) needs to process the network command and then activate the physical radio equipment. Further, Channel Quality Indicator (CQI) feedback in the new carrier is typically needed by the network before transmissions start and thus, this results in an extra delay for the use of the new carrier for data transmission. Considering XR applications and its requirements there are two major issues:
Having carriers activated at all times is not suitable from a UE power consumption point of view. All carriers might not be always needed or used.
Activating and deactivating carriers and, additionally waiting for the CQIs, takes time and, therefore, when the carrier is operative, the carrier might not be needed since the time which took to be operative may be longer than the delay budget of the application packets.

Certain aspects of the disclosure and their embodiments may provide solutions to these or other challenges. The present disclosure aims at listing solutions to reduce UE power consumption when the UE is configured with Carrier Aggregation (CA). These solutions are based on the fact that secondary carriers are activated.

Various embodiments disclosed herein provide for a method for configuring UE to be in a long sleep mode by modifying either the Discontinuous Reception (DRX) cycle in the Secondary Cells or by using Physical Downlink Control Channel (PDCCH) skipping. Once in the long sleep, the UE can be provided with an indication via the Primary Cell to start monitoring the PDCCH. If PDCCH skipping is used, the UE can be provided with an indication that would force the UE to monitor PDCCH, and the UE could be provided with an indication that would result in an “early” start of the Active Time if the DRX configuration was used. The network sends an indication to ensure secondary cell group to minimize PDCCH monitoring when a traffic is not present but to quickly restart PDCCH monitoring in the secondary cell group when traffic is present.

In a nutshell, the solution consists of 1) putting the UE in long sleep using PDCCH skipping or modifying DRX to be able to configure long DRX cycles in the secondary cells, and 2) using an indication transmitted over the primary cell (or any cell which the UE monitors PDCCH) to command the UE to start monitoring the PDCCH which would result in an “early” start of the Active Time if DRX is used, or would force the UE to monitor PDCCH if PDCCH skipping was used.

The network sends an indication to ensure secondary cell group to minimize PDCCH monitoring when a traffic is not present but quickly to restart PDCCH monitoring in the secondary cell group without extra delay when a traffic is present.

Certain embodiments may provide one or more of the following technical advantage(s). The solutions will give benefits to:
Reduce latency to transmit Physical Downlink Shared Channel (PDSCH) in Secondary Cells (SCell) without any activation delay of SCells;
Reduce PDCCH monitoring power consumption in the secondary cell group using dynamic indication; and
Medium Access Control (MAC) Control Element (CE) activation of DRX in one or more SCells.

In the current Third Generation Partnership Program (3GPP) standard, when CA is configured, to reduce UE power consumption, the NW can activate and deactivate secondary cells via MAC Control Elements. The primary cell cannot be deactivated, it is always activated. When DRX is configured with CA, two DRX groups can be configured. Each of these groups may have different values for the inactivity timer and onDuration. In addition, PDCCH skipping, or Search Space Set Group (SSSG) switching, can be used today to command the UE to not monitor PDCCH for a period of time.

In our scenario, CA is configured and the SCells are activated. In one case, DRX is additionally configured and in a second case DRX is not configured. The idea is to minimize the PDCCH monitoring i.e., long non-PDCCH monitoring periods, when there is not so much traffic requiring the use of the SCells. Then, when the network decides that one or more of the SCells should be monitoring PDCCH, the NW will send a command to the UE which will command the UE to monitor PDCCH in one or more of the SCells. More details follow:

### Scenario A:

As said above, in the case in which DRX is not configured, the network can use PDCCH skipping to decrease power consumption in the SCells. Current PDCCH skipping values are limited. However, for this solution, PDCCH skipping value would be larger. This value could be pre-configured via Radio Resource Control (RRC) or indicated dynamically. When the network indicates PDCCH skipping, it would also indicate to which SCells the command applies. Alternatively, the command may apply to all activated SCells. This command could be transmitted on PDCCH or in a MAC CE which could provide more flexibility to indicate SCells. The command may also indicate the length of PDCCH skipping which could apply to all cells to which the PDCCH skipping applies, or individually for each of the SCells to which the PDCCH command skipping applies.

When the network decides that one or more of the SCells would need to monitor back PDCCH, the NW would transmit an indication to command the UE to monitor PDCCH in one or more of the SCells. Alternatively, the command could apply to all activated SCell which were not monitoring PDCCH. This command could be transmitted on PDCCH or in a MAC CE which could provide more flexibility to indicate SCells. This command would be transmitted to the UE on one of the cells which is monitoring PDCCH. In case all cells are not monitoring PDCCH, the primary cell would be the only cell in which the command can be transmitted.

The similar behavior of PDCCH monitoring or not monitoring can be achieved by SSSG switching. If one of SSSG pattern defines a pattern switch between no PDDCH monitoring and one specific PDDCH monitoring, a network can send a SSSG switching indication to command the UE to monitor PDCCH back in or more of the SCells. The opposite way is also possible, i.e., a network commanding the UE not to monitor PDDCH from monitoring PDCCH.

This indication (either no PDCCH skipping or SSSG switching to PDCCH monitoring) could also trigger the UE to provide updated Channel State Information (CSI) information for those secondary carriers instead of waiting for the preconfigured occasion of CSI report. This triggering could be explicitly configured via RRC i.e., the network could select whether to request the UE to trigger a CSI or not when the indication is received. Alternatively, it could be mandated so the UE would always trigger the CSI. The UE would then report the CSI in the next earliest time slot in uplink or predetermined time after receiving the indication. CSI report would be transmitted via a primary carrier or in any other PUCCH as configured by the network. The indication can also be explicit to inform a UE about the format of CSI report, the timing for the report, carriers for measurement, and a specific carrier via which the report is carried.

### Scenario B:

In the case in which DRX is configured, the network could configure different DRX cycles (while this embodiment is currently not supported in the standard, it might be a possible solution in the future). The DRX cycles in the selected SCells would be long i.e., the UE would not monitor PDCCH in those selected SCells for a long period of time.

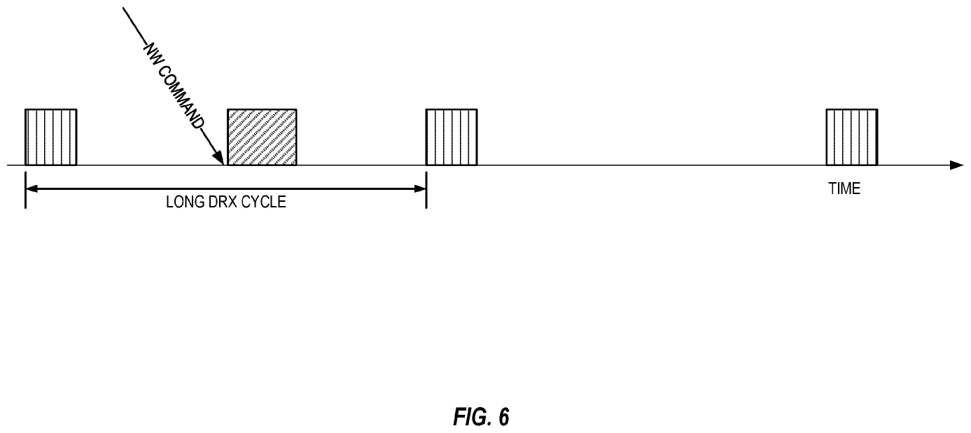

When, and if, the NW wants to use one or more of those SCells which have long DRX cycles, the NW would transmit a command to the UE indicated the one or more SCells which would need to exit the DRX cycle. In this case, those SCells would start a OnDuration timer applying a value as configured in the specific DRX configuration, or a second value which would only apply when the UE receives the command to exit the DRX cycle. In other words, it would be like 1-time command for the UE to run the OnDuration/Inactivity (or similar timers) and then continue with the regular DRX configuration. This is shown in FIG. 6. A similar approach could be used for the Inactivity timer value. This indication could be transmitted in any cell which is monitoring PDCCH; however, if no cell is monitoring PDCCH, the command would be transmitted over the primary cell.

Instead of 1-time UE exit from the current long DRX cycle, it is also possible that a network sends activation of new DRX configuration which allows more frequent PDDCH monitoring until deactivation indication is received. When another DRX configuration is activated, this indication implicitly makes a UE exit long DRX cycle and this will be continued until the deactivation of new DRX is received. The configuration of new DRX parameters can be predetermined by high layer signaling. The activation indication can also include an index value for a wanted DRX parameter set if there are multiple DRX parameter sets are predetermined.

Any one of above indications (1-time indication or activation of new DRX configuration) could also trigger the UE to provide updated CSI information for those secondary carriers instead of waiting for the preconfigured occasion of CSI report. This triggering could be explicitly configured via RRC i.e., the network could select whether to request the UE to trigger a CSI or not when the indication is received. Alternatively, it could be mandated so the UE would always trigger the CSI. The UE would then report the CSI in the next earliest time slot or predetermined time after receiving the indication. CSI report would be transmitted via a primary carrier or in any other PUCCH as configured by the network. The indication can be also explicit to inform a UE the format of CSI report, timing for the report, carriers for measurement, and a specific carrier via which the report is carried.

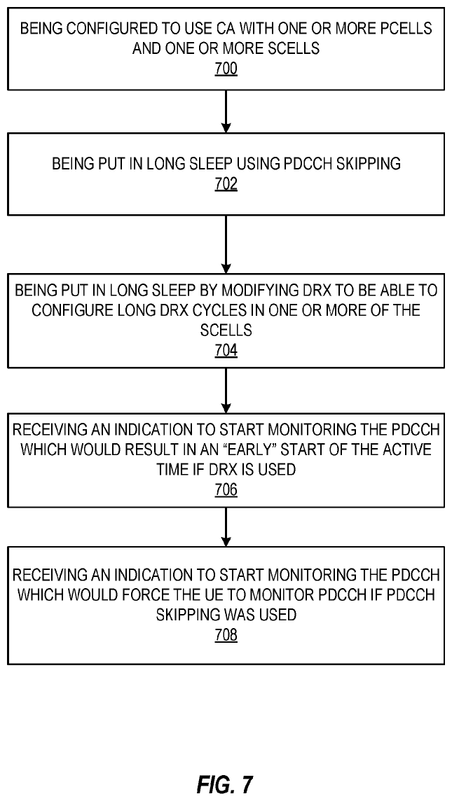

FIG. 7 illustrates a method performed by a UE for power saving, the method comprising one or more of: being configured 700 to use CA with one or more pCells and one or more SCells; being put 702 in long sleep using PDCCH skipping; being put 704 in long sleep by modifying DRX to be able to configure long DRX cycles in one or more of the SCells; receiving 706 an indication to start monitoring the PDCCH which would result in an “early” start of the Active Time if DRX is used; and receiving 708 an indication to start monitoring the PDCCH which would force the UE to monitor PDCCH if PDCCH skipping was used. In this way, latency to transmit PDSCH in SCells can be reduced without any activation delay of SCells. In this way, PDCCH monitoring power consumption can be reduced in the secondary cell group using dynamic indication.

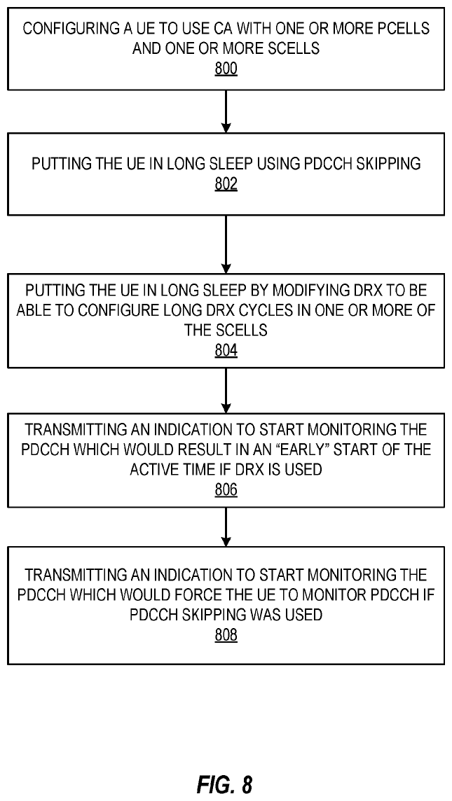

FIG. 8 illustrates a method performed by a network node for enabling power saving, the method comprising one or more of: configuring 800 a UE to use CA with one or more pCells and one or more SCells; putting 802 the UE in long sleep using PDCCH skipping; putting 804 the UE in long sleep by modifying DRX to be able to configure long DRX cycles in one or more of the SCells; transmitting 806, to the UE, an indication to start monitoring the PDCCH which would result in an “early” start of the Active Time if DRX is used; and transmitting 808, to the UE, an indication to start monitoring the PDCCH which would force the UE to monitor PDCCH if PDCCH skipping was used. In this way, latency to transmit PDSCH in SCells can be reduced without any activation delay of SCells. In this way, PDCCH monitoring power consumption can be reduced in the secondary cell group using dynamic indication.

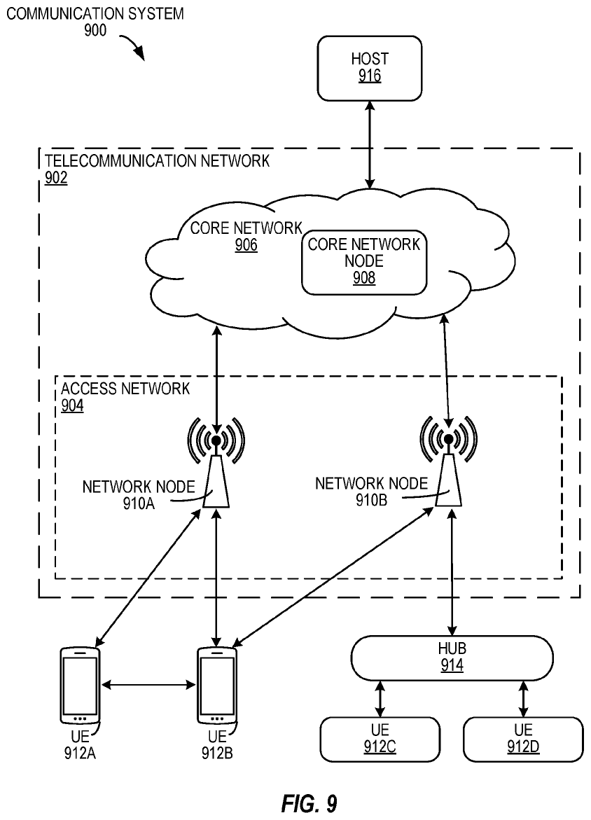

FIG. 9 shows an example of a communication system 900 in accordance with some embodiments.

In the example, the communication system 900 includes a telecommunication network 902 that includes an access network 904, such as a Radio Access Network (RAN), and a core network 906, which includes one or more core network nodes 908. The access network 904 includes one or more access network nodes, such as network nodes 910A and 910B (one or more of which may be generally referred to as network nodes 910), or any other similar Third Generation Partnership Project (3GPP) access node or non-3GPP Access Point (AP). The network nodes 910 facilitate direct or indirect connection of UE, such as by connecting UEs 912A, 912B, 912C, and 912D (one or more of which may be generally referred to as UEs 912) to the core network 906 over one or more wireless connections. The UEs 912 described herein can be the UEs that perform the method as described in FIG. 7. The network nodes 910 described herein can be the network nodes that perform the method as described in FIG. 8.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902 and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system 900 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 902 is a cellular network that implements 3GPP standardized features. Accordingly, the telecommunication network 902 may support network slicing to provide different logical networks to different devices that are connected to the telecommunication network 902. For example, the telecommunication network 902 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 914 communicates with the access network 904 to facilitate indirect communication between one or more UEs (e.g., UE 912C and/or 912D) and network nodes (e.g., network node 910B). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a Virtual Reality (VR) headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910B. The hub 914 may also allow for a different communication scheme and/or schedule between the hub 914 and UEs (e.g., UE 912C and/or 912D), and between the hub 914 and the core network 906. In other examples, the hub 914 is connected to the core network 906 and/or one or more UEs via a wired connection. Moreover, the hub 914 may be configured to connect to a Machine-to-Machine (M2M) service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910B. In other embodiments, the hub 914 may be a non-dedicated hub—that is, a device which is capable of operating to route communications between the UEs and the network node 910B, but which is additionally capable of operating as a communication start and/or end point for certain data channels.

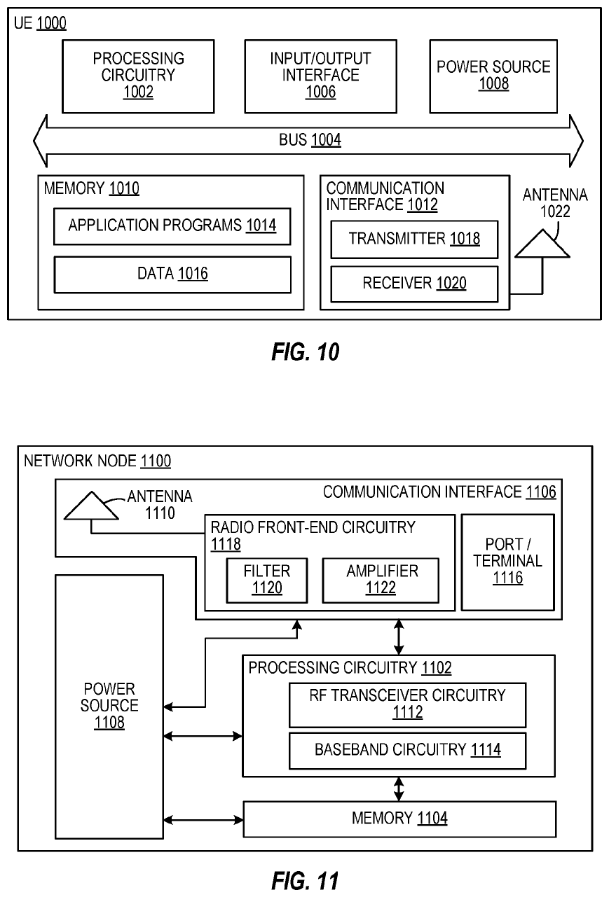

FIG. 10 shows a UE 1000 in accordance with some embodiments. The UE 1000 can be an example of the UE 912 described in FIG. 9. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1002 may include multiple Central Processing Units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging the power source 1008. Power circuitry may perform any formatting, converting, or other modification to the power from the power source 1008 to make the power suitable for the respective components of the UE 1000 to which power is supplied.

The memory 1010 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1010 may allow the UE 1000 to access instructions, application programs, and the like stored on transitory or non-transitory memory media, to off-load data, or to upload data. An article of manufacture, such as one utilizing a communication system, may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., the antenna 1022) and may share circuit components, software, or firmware, or alternatively be implemented separately.

In the illustrated embodiment, communication functions of the communication interface 1012 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1012, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 11 shows a network node 1100 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)). The network node 1100 can be an example of the network nodes 910 described in FIG. 9.

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes processing circuitry 1102, memory 1104, a communication interface 1106, and a power source 1108. The network node 1100 may be composed of multiple physically separate components (e.g., a Node B component and an RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1100 may be configured to support multiple RATs. In such embodiments, some components may be duplicated (e.g., separate memory 1104 for different RATs) and some components may be reused (e.g., an antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1100.

The processing circuitry 1102 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1100 components, such as the memory 1104, to provide network node 1100 functionality.

In some embodiments, the processing circuitry 1102 includes a System on a Chip (SOC). In some embodiments, the processing circuitry 1102 includes one or more of Radio Frequency (RF) transceiver circuitry 1112 and baseband processing circuitry 1114. In some embodiments, the RF transceiver circuitry 1112 and the baseband processing circuitry 1114 may be on separate chips (or sets of chips), boards, or units, such as radio units and digital units. In alternative embodiments, part or all of the RF transceiver circuitry 1112 and the baseband processing circuitry 1114 may be on the same chip or set of chips, boards, or units.

The memory 1104 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and the memory 1104 are integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. The radio front-end circuitry 1118 comprises filters 1120 and amplifiers 1122. The radio front-end circuitry 1118 may be connected to the antenna 1110 and the processing circuitry 1102. The radio front-end circuitry 1118 may be configured to condition signals communicated between the antenna 1110 and the processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of the filters 1120 and/or the amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface 1106 may comprise different components and/or different combinations of components.

In certain alternative embodiments, the network node 1100 does not include separate radio front-end circuitry 1118; instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes the one or more ports or terminals 1116, the radio front-end circuitry 1118, and the RF transceiver circuitry 1112 as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, the communication interface 1106, and/or the processing circuitry 1102 may be configured to perform any receiving operations and/or certain obtaining operations described herein as being performed by the network node 1100. Any information, data, and/or signals may be received from a UE, another network node, and/or any other network equipment. Similarly, the antenna 1110, the communication interface 1106, and/or the processing circuitry 1102 may be configured to perform any transmitting operations described herein as being performed by the network node 1100. Any information, data, and/or signals may be transmitted to a UE, another network node, and/or any other network equipment.

The power source 1108 provides power to the various components of the network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid or an electricity outlet) via input circuitry or an interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

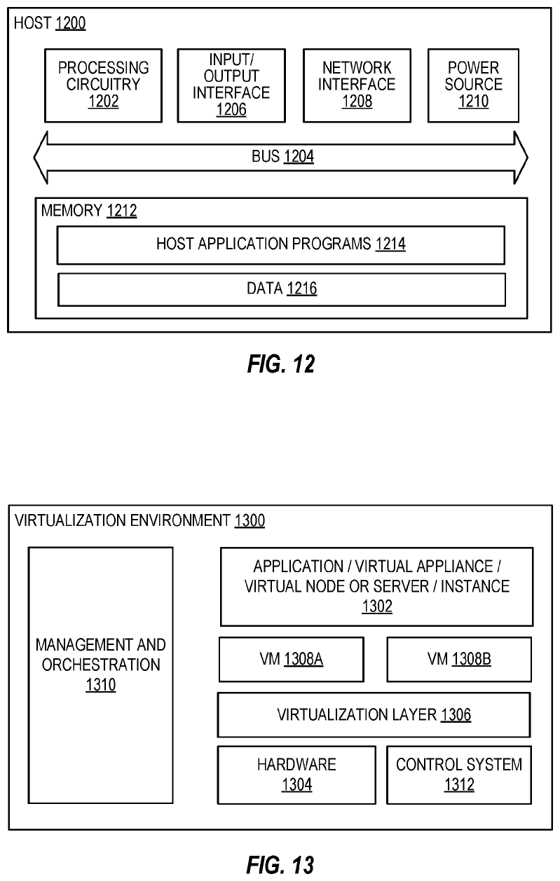

FIG. 12 is a block diagram of a host 1200, which may be an embodiment of the host 916 of FIG. 9, in accordance with various aspects described herein. As used herein, the host 1200 may be or comprise various combinations of hardware and/or software including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and memory 1212. Other components may be included in other embodiments. Features of these components may be substantially similar to those described with respect to the devices of previous figures, such as FIGS. 10 and 11, such that the descriptions thereof are generally applicable to the corresponding components of the host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for Over-The-Top (OTT) services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or VM Monitors (VMMs)), provide VMs 1308A and 1308B (one or more of which may be generally referred to as VMs 1308), and/or perform any of the functions, features, and/or benefits described in relation with some embodiments described herein. The virtualization layer 1306 may present a virtual operating platform that appears like networking hardware to the VMs 1308.

The VMs 1308 comprise virtual processing, virtual memory, virtual networking, or interface and virtual storage, and may be run by a corresponding virtualization layer 1306. Different embodiments of the instance of a virtual appliance 1302 may be implemented on one or more of the VMs 1308, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1308 may be a software implementation of a physical machine that runs programs as if they were executing on a physical, non-virtualized machine. Each of the VMs 1308, and that part of the hardware 1304 that executes that VM, be it hardware dedicated to that VM and/or hardware shared by that VM with others of the VMs 1308, forms separate virtual network elements. Still in the context of NFV, a virtual network function is responsible for handling specific network functions that run in one or more VMs 1308 on top of the hardware 1304 and corresponds to the application 1302.

The hardware 1304 may be implemented in a standalone network node with generic or specific components. The hardware 1304 may implement some functions via virtualization. Alternatively, the hardware 1304 may be part of a larger cluster of hardware (e.g., such as in a data center or CPE) where many hardware nodes work together and are managed via management and orchestration 1310, which, among others, oversees lifecycle management of the applications 1302. In some embodiments, the hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1312 which may alternatively be used for communication between hardware nodes and radio units.

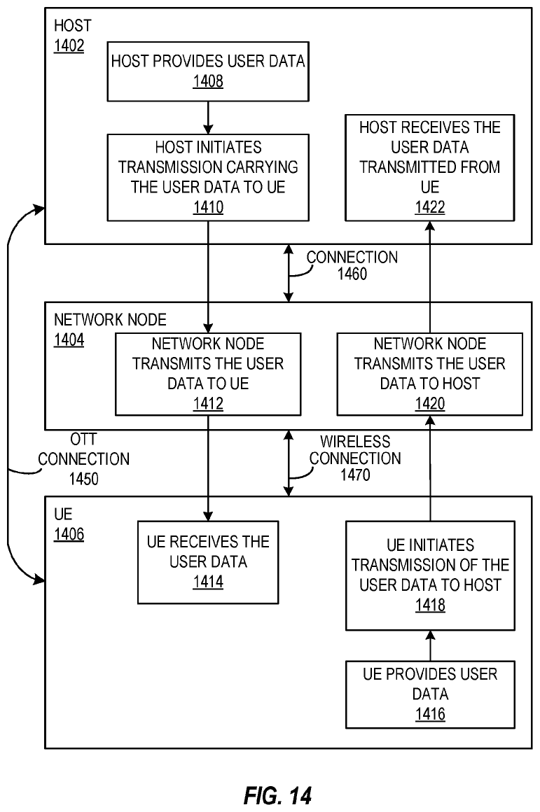

FIG. 14 shows a communication diagram of a host 1402 communicating via a network node 1404 with a UE 1406 over a partially wireless connection in accordance with some embodiments. Example implementations, in accordance with various embodiments, of the UE (such as the UE 912A of FIG. 9 and/or the UE 1000 of FIG. 10), the network node (such as the network node 910A of FIG. 9 and/or the network node 1100 of FIG. 11), and the host (such as the host 916 of FIG. 9 and/or the host 1200 of FIG. 12) discussed in the preceding paragraphs will now be described with reference to FIG. 14.

Like the host 1200, embodiments of the host 1402 include hardware, such as a communication interface, processing circuitry, and memory. The host 1402 also includes software, which is stored in or is accessible by the host 1402 and executable by the processing circuitry. The software includes a host application that may be operable to provide a service to a remote user, such as the UE 1406 connecting via an OTT connection 1450 extending between the UE 1406 and the host 1402. In providing the service to the remote user, a host application may provide user data which is transmitted using the OTT connection 1450.

The network node 1404 includes hardware enabling it to communicate with the host 1402 and the UE 1406 via a connection 1460. The connection 1460 may be direct or pass through a core network (like the core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by the UE 1406 and executable by the UE's processing circuitry. The software includes a client application, such as a web browser or operator-specific “app” that may be operable to provide a service to a human or non-human user via the UE 1406 with the support of the host 1402. In the host 1402, an executing host application may communicate with the executing client application via the OTT connection 1450 terminating at the UE 1406 and the host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via the connection 1460 between the host 1402 and the network node 1404 and via a wireless connection 1470 between the network node 1404 and the UE 1406 to provide the connection between the host 1402 and the UE 1406. The connection 1460 and the wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404 in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR, or AR which it can broadcast, multicast, or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1450 between the host 1402 and the UE 1406 in response to variations in the measurement results. The measurement procedure and/or the network functionality for reconfiguring the OTT connection 1450 may be implemented in software and hardware of the host 1402 and/or the UE 1406. In some embodiments, sensors (not shown) may be deployed in or in association with other devices through which the OTT connection 1450 passes; the sensors may participate in the measurement procedure by supplying values of the monitored quantities exemplified above, or by supplying values of other physical quantities from which software may compute or estimate the monitored quantities. The reconfiguring of the OTT connection 1450 may include message format, retransmission settings, preferred routing, etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency, and the like by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Some of the embodiments of the disclosure include, but are not limited to:

Embodiment 1: A method performed by a User Equipment, UE, for power saving, the method comprising one or more of: being configured (700) to use Carrier Aggregation, CA, with one or more Primary Cells, pCells, and one or more Secondary Cells, SCells; being put (702) in long sleep using Physical Downlink Control Channel, PDCCH, skipping; being put (704) in long sleep by modifying DRX to be able to configure long Discontinuous Reception, DRX, cycles in one or more of the SCells; receiving (706) an indication to start monitoring the PDCCH which would result in an “early” start of the Active Time if DRX is used; and receiving (708) an indication to start monitoring the PDCCH which would force the UE to monitor PDCCH if PDCCH skipping was used.

Embodiment 2: The method of embodiment 1 wherein the indication to start monitoring the PDCCH is received over a cell on which the UE monitors PDCCH.

Embodiment 3: The method of any of the previous embodiments wherein the indication to start monitoring the PDCCH is received over a pCell.

Embodiment 4: The method of any of the previous embodiments wherein the indication to start monitoring the PDCCH is for one or more SCells.

Embodiment 5: The method of any of the previous embodiments wherein a PDCCH skipping value is pre-configured via RRC or indicated dynamically.

Embodiment 6: The method of any of the previous embodiments wherein a PDCCH skipping indication also indicates to which SCells the command applies.

Embodiment 7: The method of any of the previous embodiments wherein a PDCCH skipping indication applies to all SCells.

Embodiment 8: The method of any of the previous embodiments wherein a PDCCH skipping indication is received on PDCCH or in a MAC CE.

Embodiment 9: The method of any of the previous embodiments wherein a PDCCH skipping indication indicates the length of PDCCH skipping which could apply to all cells to which the PDCCH skipping applies, or individually for each of the SCells to which the PDCCH command skipping applies.

Embodiment 10: The method of any of the previous embodiments further comprising: receiving a SSSG switching indication to command the UE to monitor PDCCH back in or more of the SCells.

Embodiment 11: The method of any of the previous embodiments further comprising: receiving a SSSG switching indication to command the UE to not monitor PDCCH from monitoring PDCCH.

Embodiment 12: The method of any of the previous embodiments wherein being configured with DRX cycles in the selected SCells would be long (i.e., the UE would not monitor PDCCH in those selected SCells for long period of time).

Embodiment 13: The method of any of the previous embodiments further comprising: receiving an indication that one or more SCells need to exit the DRX cycle.

Embodiment 14: The method of any of the previous embodiments wherein those SCells would start a OnDuration timer applying a value as configured in the specific DRX configuration, or a second value which would only apply when the UE receives the command to exit the DRX cycle.

Embodiment 15: The method of any of the previous embodiments further comprising receiving activation of a new DRX configuration which allows more frequent PDDCH monitoring until deactivation indication is received.

Embodiment 16: The method of any of the previous embodiments wherein, when another DRX configuration is activated, this indication implicitly makes a UE exit long DRX cycle and this will be continued until the deactivation of new DRX is received.

Embodiment 17: The method of any of the previous embodiments wherein the configuration of new DRX parameters can be predetermined by high layer signaling.

Embodiment 18: The method of any of the previous embodiments wherein the activation indication can also include an index value for a wanted DRX parameter set if there are multiple DRX parameter sets are predetermined.

Embodiment 19: The method of any of the previous embodiments wherein any one of above indications also trigger the UE to provide updated CSI information for those secondary carriers instead of waiting for the preconfigured occasion of CSI report.

Embodiment 20: The method of any of the previous embodiments wherein the indication also triggers the UE to provide updated CSI information for those secondary carriers instead of waiting for the preconfigured occasion of CSI report.

Embodiment 21: The method of any of the previous embodiments wherein triggering could be explicitly configured via RRC (i.e., the network could select whether to request the UE to trigger a CSI or not when the indication is received).

Embodiment 22: The method of any of the previous embodiments wherein the UE would always trigger the CSI.

Embodiment 23: The method of any of the previous embodiments further comprising: reporting the CSI in the next earliest time slot in uplink or predetermined time after receiving the indication.

Embodiment 24: The method of any of the previous embodiments wherein a CSI report is transmitted via a primary carrier or in any other PUCCH as configured by the network.

Embodiment 25: The method of any of the previous embodiments wherein the indication comprises one or more of: the format of CSI report; a timing for the report; carriers for measurement; and a specific carrier via which the report is carried.

Embodiment 26: The method of any of the previous embodiments wherein the latency to transmit PDSCH in SCells is reduced with less activation delay of SCells.

Embodiment 27: The method of any of the previous embodiments wherein the PDCCH monitoring power consumption is reduced in the secondary cell group using dynamic indication.

Embodiment 28: The method of any of the previous embodiments, further comprising: providing user data; and forwarding the user data to a host via the transmission to the network node.

Embodiment 29: A method performed by a network node for enabling power saving, the method comprising one or more of configuring (800) a User Equipment, UE, to use Carrier Aggregation, CA, with one or more Primary Cells, pCells, and one or more Secondary Cells, SCells; putting (802) the UE in long sleep using Physical Downlink Control Channel, PDCCH, skipping; putting (804) the UE in long sleep by modifying DRX to be able to configure long Discontinuous Reception, DRX, cycles in one or more of the SCells; transmitting (806), to the UE, an indication to start monitoring the PDCCH which would result in an “early” start of the Active Time if DRX is used; and transmitting (808), to the UE, an indication to start monitoring the PDCCH which would force the UE to monitor PDCCH if PDCCH skipping was used.

Embodiment 30: The method of embodiment 1 wherein the indication to start monitoring the PDCCH is received over a cell on which the UE monitors PDCCH.

Embodiment 31: The method of any of the previous embodiments wherein the indication to start monitoring the PDCCH is received over a pCell.

Embodiment 32: The method of any of the previous embodiments wherein the indication to start monitoring the PDCCH is for one or more SCells.

Embodiment 33: The method of any of the previous embodiments wherein a PDCCH skipping value is pre-configured via RRC or indicated dynamically.

Embodiment 34: The method of any of the previous embodiments wherein a PDCCH skipping indication also indicates to which SCells the command applies.

Embodiment 35: The method of any of the previous embodiments wherein a PDCCH skipping indication applies to all SCells.

Embodiment 36: The method of any of the previous embodiments wherein a PDCCH skipping indication is received on PDCCH or in a MAC CE.

Embodiment 37: The method of any of the previous embodiments wherein a PDCCH skipping indication indicates the length of PDCCH skipping which could apply to all cells to which the PDCCH skipping applies, or individually for each of the SCells to which the PDCCH command skipping applies.

Embodiment 38: The method of any of the previous embodiments further comprising: receiving a SSSG switching indication to command the UE to monitor PDCCH back in or more of the SCells.

Embodiment 39: The method of any of the previous embodiments further comprising: receiving a SSSG switching indication to command the UE to not monitor PDCCH from monitoring PDCCH.

Embodiment 40: The method of any of the previous embodiments wherein being configured with DRX cycles in the selected SCells would be long (i.e., the UE would not monitor PDCCH in those selected SCells for long period of time).

Embodiment 41: The method of any of the previous embodiments further comprising: receiving an indication that one or more SCells need to exit the DRX cycle.

Embodiment 42: The method of any of the previous embodiments wherein those SCells would start a OnDuration timer applying a value as configured in the specific DRX configuration, or a second value which would only apply when the UE receives the command to exit the DRX cycle.

Embodiment 43: The method of any of the previous embodiments further comprising receiving activation of a new DRX configuration which allows more frequent PDDCH monitoring until deactivation indication is received.

Embodiment 44: The method of any of the previous embodiments wherein, when another DRX configuration is activated, this indication implicitly makes a UE exit long DRX cycle and this will be continued until the deactivation of new DRX is received.

Embodiment 45: The method of any of the previous embodiments wherein the configuration of new DRX parameters can be predetermined by high layer signaling.

Embodiment 46: The method of any of the previous embodiments wherein the activation indication can also include an index value for a wanted DRX parameter set if there are multiple DRX parameter sets are predetermined.

Embodiment 47: The method of any of the previous embodiments wherein any one of above indications also trigger the UE to provide updated CSI information for those secondary carriers instead of waiting for the preconfigured occasion of CSI report.

Embodiment 48: The method of any of the previous embodiments wherein the indication also triggers the UE to provide updated CSI information for those secondary carriers instead of waiting for the preconfigured occasion of CSI report.

Embodiment 49: The method of any of the previous embodiments wherein triggering could be explicitly configured via RRC (i.e., the network could select whether to request the UE to trigger a CSI or not when the indication is received).

Embodiment 50: The method of any of the previous embodiments wherein the UE would always trigger the CSI.

Embodiment 51: The method of any of the previous embodiments further comprising: reporting the CSI in the next earliest time slot in uplink or predetermined time after receiving the indication.

Embodiment 52: The method of any of the previous embodiments wherein a CSI report is transmitted via a primary carrier or in any other PUCCH as configured by the network.

Embodiment 53: The method of any of the previous embodiments wherein the indication comprises one or more of: the format of CSI report; a timing for the report; carriers for measurement; and a specific carrier via which the report is carried.

Embodiment 54: The method of any of the previous embodiments wherein the latency to transmit PDSCH in SCells is reduced with less activation delay of SCells.

Embodiment 55: The method of any of the previous embodiments wherein the PDCCH monitoring power consumption is reduced in the secondary cell group using dynamic indication.

At least some of the following abbreviations may be used in this disclosure. If there is an inconsistency between abbreviations, preference should be given to how it is used above. If listed multiple times below, the first listing should be preferred over any subsequent listing(s).

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, a configuration to use Carrier Aggregation (CA) with one or more Primary Cells (PCells) and one or more Secondary Cells (SCells);
receiving, from the network node, a configuration to be put in a long sleep using either Physical Downlink Control Channel (PDCCH) skipping or by modifying Discontinuous Reception (DRX) to configure long DRX cycles in one or more of the SCells; and
if the configuration is to use PDCCH skipping, receiving, from the network node, an indication to force monitoring of the PDCCH; or
if the configuration is to modify DRX, receiving, from the network node, an indication to initiate a start of the Active Time of DRX, resulting in the monitoring of the PDCCH.

2. The method of claim 1, wherein the indication is received over a cell on which the UE is monitoring the PDCCH.

3. The method of claim 2, wherein the cell is a PCell.

4. The method of claim 1, wherein the indication is for one or more SCells.

5. The method of claim 1, wherein a PDCCH skipping value is pre-configured via Radio Resource Control, RRC, or is indicated dynamically.

6. The method of claim 1, wherein the configuration to use PDCCH skipping indication also indicates to which SCells the configuration applies.

7. The method of claim 1, wherein a PDCCH skipping indication applies to all SCells of the one or more SCells.

8. The method of claim 1, wherein the configuration to use PDCCH skipping is received via PDCCH or in a Medium Access Control (MAC) Control Element (CE).

9. The method of claim 1, wherein the configuration to use PDCCH skipping indicates a length of PDCCH skipping which applies to all cells to which the PDCCH skipping applies, or individually for each of the SCells to which the PDCCH skipping applies.

10. A User Equipment device (UE) that is configured to receive a configuration to be in a long sleep mode, the UE comprising a radio and processing circuitry that is configured to:
receive, from a network node, a configuration to use Carrier Aggregation (CA) with one or more Primary Cells (PCells) and one or more Secondary Cells (SCells);
receive, from the network node, a configuration to be put in a long sleep using either Physical Downlink Control Channel (PDCCH) skipping or by modifying Discontinuous Reception (DRX) to configure long DRX cycles in one or more of the SCells; and
if the configuration is to use PDCCH skipping, receiving, from the network node, an indication to force monitoring of the PDCCH; or
if the configuration is to modify DRX, receiving, from the network node, an indication to initiate a start of the Active Time of DRX, resulting in the monitoring of the PDCCH.

11. A method performed by a network node, the method comprising:
providing a configuration to use Carrier Aggregation (CA) with one or more Primary Cells (PCells) and one or more Secondary Cells (SCells);
providing a configuration to put the UE in a long sleep using either Physical Downlink Control Channel, PDCCH, skipping or by modifying Discontinuous Reception (DRX) to configure long DRX cycles in one or more of the SCells; and
if the configuration is to use PDCCH skipping, providing an indication to force monitoring of the PDCCH; or
if the configuration is to modify DRX, providing an indication to initiate a start of the Active Time of DRX, resulting in the monitoring of the PDCCH.

12. The method of claim 11, wherein the indications are provided over a cell on which the UE is monitoring the PDCCH.

13. The method of claim 12, wherein the cell is a PCell.

14. The method of claim 11, wherein the indication is for one or more SCells.

15. The method of claim 11, wherein a PDCCH skipping value is pre-configured via Radio Resource Control (RRC) or is indicated dynamically.

16. The method of claim 11, wherein the configuration to use PDCCH skipping indication also indicates to which SCells the configuration applies.

17. The method of claim 11, wherein a PDCCH skipping indication applies to all SCells of the one or more SCells.

18. The method of claim 11, wherein the configuration to use PDCCH skipping is received via PDCCH or in a Medium Access Control (MAC) Control Element (CE).

19. The method of claim 11, wherein the configuration to use PDCCH skipping indicates a length of PDCCH skipping which applies to all cells to which the PDCCH skipping applies, or individually for each of the SCells to which the PDCCH skipping applies.

20. A network node, the network node comprising a radio and processing circuitry that is configured to:
providing a configuration to use Carrier Aggregation (CA) with one or more Primary Cells (PCells) and one or more Secondary Cells (SCells);
providing a configuration to put the UE in a long sleep using either Physical Downlink Control Channel, PDCCH, skipping or by modifying Discontinuous Reception (DRX) to configure long DRX cycles in one or more of the SCells; and
if the configuration is to use PDCCH skipping, providing an indication to force monitoring of the PDCCH; or
if the configuration is to modify DRX, providing an indication to initiate a start of the Active Time of DRX, resulting in the monitoring of the PDCCH.
